(19) United States
(12) Patent Application Publication
(10) Pub. No.: US 2024/0182678 A1
(43) Pub. Date: Jun. 6, 2024

(54) PROPELLANT ELEMENT AND METHOD FOR PRODUCING THE PROPELLANT ELEMENT

(71) Applicant: ZF AIRBAG GERMANY GMBH, Aschau a. Inn (DE)

(72) Inventor: Sebastian WIENHOLD, Anzing (DE)

(21) Appl. No.: 18/522,459

(22) Filed: Nov. 29, 2023

(30) Foreign Application Priority Data
Dec. 1, 2022 (DE) 10 2022 131 842.7

(51) Int. Cl. C08K 5/09

(52) U.S. Cl. CPC C08K 5/09

(57) ABSTRACT

The invention relates to a propellant element, the propellant element comprising the following components:
at least one pyrotechnical material;
at least one processing agent based on a monocarboxylic acid with the following formula

R—COOH

wherein R is an organic residue. Furthermore, a method for producing the propellant element is described.

### TECHNICAL FIELD

The invention relates to a propellant element for a safety device and a method for producing the propellant element.

### BACKGROUND

Propellant elements for safety devices are known in prior art. Usually, propellant elements are used in gas generators for safety apparatuses, specifically in safety devices for vehicles and passenger protection devices. In order to protect vehicle occupants in the case of collision, different safety devices are provided in a vehicle. Such safety device can be, for example, an airbag module equipped with a gas generator. In the case of an imminent collision of the vehicle with another object, the gas generator releases compressed gas that deploys an airbag out of the airbag module, thus causing the vehicle occupants to be restrained. Further applications are gas generators for belt tensioners or a pedestrian impact protection.

Gas generators serve for generating compressed gas and are known in various embodiments. Basically, gas generators make use of a propellant element that is disposed inside the gas generator and, when activated by an electrical igniter, releases compressed gas which can be used to inflate an airbag or to drive a belt tensioner.

Propellant elements are provided in the form of pellets which can be produced in different ways. Usually, those pellets are produced by pressing a propellant composite. The propellant composite is present as a powder mixture before pressing and as a main component includes a pyrotechnical material which comprises a fuel and an oxidizing agent. Further components such as combustion modifiers, binders, stabilizers, drying agents and slag formers may be added to the propellant composite.

The above-mentioned components are mixed before they are pressed to form the propellant element. For this purpose, the components are ground together. In order to improve grinding of the different components of the propellant composite and subsequent pressing to form the propellant element, it is known to add specific processing agents to the propellant composite prior to the afore-mentioned method steps. In the production of the propellant pellet, processing agents act specifically as pressing agents, anti-caking agents and/or as lubricants and, thus, improve the handling of the propellant composite and the propellant element.

Examples of processing agents known from prior art are polyethylene glycol, cellulose, methyl cellulose, graphite, wax, calcium stearate, magnesium stearate, zinc stearate, boron nitrite, talcum, bentonite, silicon dioxide and molybdenum sulfite as well as the mixtures thereof.

Moreover, processing agents can also influence substantial features of the completely pressed propellant element such as the ignitability and the burn-off behavior. As a consequence, endeavors are made to find new processing agents which are suited for producing a propellant element for a safety device and which improve the characteristics of the propellant composite and/or the propellant element.

### SUMMARY

In this respect, it is the object underlying the present invention to provide a processing agent which allows simple and inexpensive production of a propellant element in terms of process and material cost and which meets the performance requirements made for use in a propellant element.

According to the invention, the object is achieved by a propellant element for a safety device according to claim 1.

Advantageous embodiments of the propellant element according to the invention are stated in the subclaims which can be optionally combined with each other.

### DESCRIPTION

In accordance with the invention, the object is achieved by a propellant element for a safety device, the propellant element comprising the following components:
(A) at least one pyrotechnical material;
(B) at least one processing agent based on a monocarboxylic acid with the following formula

R—COOH

wherein R is an organic residue.

The invention is based on the finding of the inventors that a monocarboxylic acid is suited as processing agent for the production of a propellant element. The use of the monocarboxylic acid results in propellant composites having a significantly higher bulk density than propellant composites which have been produced with conventional processing agents such as stearate salts. A higher bulk density means a higher density of the pyrotechnical material per volume unit, resulting in an improved processability of the propellant composite. Further, monocarboxylic acids have a reduced sensitivity to oxidation as compared to known processing agents based on negatively charged carboxylates. Hence, the propellant elements according to the invention are more stable vis-à-vis oxidation reactions. Consequently, the propellant element according to the invention has an increased stability vis-à-vis high temperatures and temperature changes. Moreover, the breaking strength of the propellant elements is improved, and the addition of drying agents can be significantly reduced.

The propellant element according to the invention is provided for use in a gas generator for a safety device. The most widely known safety devices are vehicle occupant restraint systems as they are used in vehicles for passenger transport. Such a system comprises substantially an airbag module including a gas generator and an airbag connected to the gas generator. In the case of a trigger scenario, the gas generator provides compressed gas which deploys the airbag. The deployed airbag is additionally filled by the inflowing compressed gas to provide a restraining effect for a vehicle occupant. The compressed gas can be provided in this case by converting the propellant element according to the invention in the gas generator.

The propellant element is moreover provided to be used in other safety devices. These include specifically safety devices comprising airbag modules with gas generators for electric scooters and child seats as well as pyrotechnical drives for belt tensioner modules. Also provided is the use of the propellant element in personal protection equipment, such as in airbag modules for avalanche protective clothing, motorbike helmets or bicycle helmets.

According to the invention, the propellant element comprises, apart from the processing agent, a pyrotechnical material as component (A).

The pyrotechnical material of component (A) may comprise a fuel and an oxidation agent.

Basically, the fuel is not limited and any fuel known from prior art can be used which is suitable for being utilized in a propellant element for use in a gas generator.

The fuel is preferably selected from the group consisting of guanidine nitrate, nitroguanidine, triamino guanidine nitrate, urea nitrate, nitro-urea, nitro-penta, nitro-triazolone, hexogen, octogen and mixtures thereof. Particularly preferred is the guanidine nitrate and/or nitroguanidine fuel. Guanidine nitrate is the most preferred fuel.

The oxidizing agent not limited, either, and any oxidizing agent known from prior art can be used which is suitable for being utilized in a propellant element for use in a gas generator.

The oxidizing agent is preferably selected from the group consisting of nitrates, oxides and/or mixed oxides of the alkali metals, alkaline-earth metals and transition metals, transition metal nitrate hydroxides, chlorates, perchlorates, ammonium hydrates, sulfates, phosphates, oxalates, dinitramides, peroxides and combinations thereof.

Apart from the pyrotechnical material of the component (A), the propellant element comprises, according to the invention, at least one processing agent of the component (B) based on a monocarboxylic acid with the formula R—COOH, R being an organic residue.

The processing agent based on a monocarboxylic acid is basically not limited and any known monocarboxylic acid having an organic residue R can be used as processing agent.

In accordance with the invention, monocarboxylic acid is understood to be a chemical compound functionalized with only one carboxy group (—COOH). Accordingly, the organic residue R has merely one carboxy group. Di- or tri-carboxylic acids are excluded from the invention.

According to a first aspect of the invention, the organic residue R comprises an aliphatic and/or aromatic hydrocarbon skeleton. The aromatic hydrocarbon skeleton may be a homoaromatic or heteroaromatic hydrocarbon skeleton. The aliphatic hydrocarbon skeleton may be a linear, branched or cyclic hydrocarbon skeleton which may optionally contain one or more heteroatoms. The heteroatoms in the aliphatic or aromatic hydrocarbon skeleton may be selected from the group consisting of nitrogen, oxygen, sulfur and phosphorus. Further, the hydrocarbon skeleton may be saturated or unsaturated.

Another aspect provides that the hydrocarbon skeleton is selected from the group consisting of C1-C17 alkyl, C2-C17 alkenyl, C2-C17 alkynyl, C6-C12 cycloalkyl and C6-C14 aryl as well as mixtures thereof.

The term C1-C17 alkyl in accordance with the invention comprises linear or branched saturated hydrocarbon groups having 1 to 17 hydrocarbon atoms. Preferred hydrocarbon groups comprise, for example, methyl, ethyl, n-propyl, isopropyl, n-butyl, sec-butyl, iso-butyl, tert-butyl, n-pentyl, iso-pentyl, 2,2-dimethylpropyl, n-hexyl, iso-hexyl, 2-ethylhexyl, n-heptyl, iso-heptyl, n-octyl, iso-octyl, 1-dodecyl, 1-tetradecyl and 1-heptadecyl.

The term C2-C17 alkenyl in accordance with the invention comprises linear or branched, at least partially unsaturated hydrocarbon groups having 2 to 17 carbon atoms, wherein the hydrocarbon groups include at least one C-C double bond. Preferred hydrocarbon groups comprise, for example, ethenyl, 1-propenyl, 2-propenyl, 1-butenyl, 2-butenyl, iso-butenyl, 1-pentenyl, 1-hexenyl, 1-heptenyl, 1-octenyl, 1-nonenyl, 1-decenyl, 1-dodecenyl, 1-tetradecenyl and 1-heptadecenyl.

The term C2-C17 alkynyl in accordance with the invention comprises linear or branched, at least partially linear unsaturated hydrocarbon groups having 1 to 17 carbon atoms, wherein the hydrocarbon groups include at least one C-C triple bond. Preferred hydrocarbon groups comprise, for example, ethynyl, 1-propynyl, 2-propynyl, 1-butynyl, 2-butynyl, iso-butynyl, 1-pentynyl, 1-hexynyl, 1-heptynyl, 1-octynyl, 1-nonynyl, 1-decynyl, 1-dodecynyl, 1-tetradecynyl and 1-heptadecynyl.

The term C6-C12 cycloalkyl in accordance with the invention comprises cyclic saturated hydrocarbon groups having 6 to 18 carbon atoms. Preferred hydrocarbon groups comprise, for example, cyclohexyl, cycloheptyl, cyclooctyl, cyclononyl and cyclodecanyl.

The term C6-C14 aryl in accordance with the invention comprises aromatic hydrocarbon groups having six to fourteen carbon atoms. The term accordingly covers monocyclic, bicyclic and tricyclic aromatic hydrocarbon groups. Preferred aromatic hydrocarbon groups comprise, for example, phenyl, naphthyl and anthracyl.

Equally comprised by the term C6-C14 aryl are heteroaromatic hydrocarbon groups having at least one heteroatom that is selected from the group consisting of nitrogen, oxygen, sulfur and phosphorus. Suitable heteroaromatic hydrocarbon groups having at least one heteroatom comprise pyridyl, furanyl, pyrrolyl and indolyl, for example.

Specifically, ether and/or ester can be used as aliphatic hydrocarbon skeletons having at least one oxygen atom.

Suitable examples of ether residues are 2-ethoxyethyl, 2-methoxyethyl, 4-methoxybutyl, 2-(2-methoxyethoxy)ethyl and PEGyloxymethyl (PEG=polyethylene glycol having a variable molar mass).

Examples of ester residues comprise 2-acetoxymethyl and 2-(2-methoxyacetoxy)methyl.

A suitable example of an aliphatic hydrocarbon skeleton having at least one sulfur atom is thiol-PEG4.

Amines, specifically aminoether, can be used as aliphatic hydrocarbon skeletons having at least one nitrogen atom.

Suitable examples are 2-dimethylamino-1-butyl and 2-(2-dimethylaminoethoxy)ethyl.

Suitable examples of an aliphatic unsaturated hydrocarbon skeleton having at least one heteroatom are organic residues such as 6-methoxy-1-hexenyl, allyloxymethyl and 4-ethoxy-2-butinyl.

Another aspect of the invention provides that the monocarboxylic acid is liquid at room temperature. Room temperature is understood to be a temperature of 25° C. In this way, a particularly proper wettability of the pyrotechnical material of the component (A) can be ensured.

According to another embodiment, the monocarboxylic acid may have a melting point ranging from 25 to 70° C., preferably from 50 to 65° C. and particularly preferred from 55 to 60° C. Such monocarboxylic acid is solid at room temperature and can be liquefied by supplying heat, for example by frictional heat, as it occurs when grinding components of the propellant composite. Thus, a monocarboxylic acid having a melting point in the above-mentioned range can be handled and added to the component (A) in the initially solid state. Subsequently, the frictional heat occurring during mixing and specifically grinding the components can melt the monocarboxylic acid so that particularly proper mixing with the pyrotechnical material is achieved. In this respect, such monocarboxylic acid can be handled particularly easily.

According to another aspect, the monocarboxylic acid is a non-branched saturated alkanoic acid. Such alkanoic acid can also be referred to as fatty acid.

Preferably, the non-branched saturated alkanoic acid has the sum formula CnH2n+1COOH, where n is a natural number from 1 to 17, preferably from 3 to 12, particularly preferred from 4 to 9.

For example, the alkanoic acid may be selected from the group consisting of ethanoic acid, propanoic acid, butanoic acid, pentanoic acid, hexanoic acid, heptanoic acid, octanoic acid, nonanoic acid, decanoic acid, hexadecanoic acid, undecanoic acid, dodecanoic acid, tridecanoic acid, tetradecanoic acid, pentadecanoic acid, hexadecanoic acid, heptadecanoic acid and octadecanoic acid as well as of combinations thereof.

Especially preferred, n-heptanoic acid is used as processing agent based on a monocarboxylic acid.

Further, the propellant element as component (C) may comprise further additives which are selected from the group consisting of drying agents, burn-off modifiers, binders, stabilizers and slag formers as well as combinations thereof.

Suitable additives are, for example, iron oxide, magnesium oxide, amorphous silica, hydrophobic silica, calcium stearate, lubricating oil, polyethylene glycol, cellulose, methylcellulose, graphite, wax, magnesium stearate, zinc stearate, boron nitride, talcum, bentonite, silicon dioxide and molybdenum sulfide.

According to another aspect, the propellant element comprises the following components:
(A) 85 to 99.99% by weight, preferably 90 to 98% by weight, of the at least one pyrotechnical material,
(B) 0.01 to 5% by weight, preferably 0.05 to 1% by weight, particularly preferred 0.1 to 1% by weight, of the at least one processing agent based on a monocarboxylic acid, preferably a monocarboxylic acid having a C3-C9 alkyl residue, and
(C) 0 to 15% by weight, preferably 1 to 9% by weight, of further additives,
wherein the proportions of the components (A) to (C) add up to 100 percent.

Processing agents based on monocarboxylic acids are stable against hydrolysis in contrast to the conventionally used processing agents based on carboxylates. Thus, also the amount of additives, particularly the amount of drying agents, which are required in a known way to safeguard the storability of the propellant element can be reduced. Preferably, the use of drying agents in the propellant element can be completely avoided by the use of processing agents based on monocarboxylic acid.

The propellant element therefore is particularly free from stearate salts as processing agents.

Furthermore, the invention relates to a method of producing a propellant element. The method comprises the following steps of:
a) mixing the at least one pyrotechnical material, optionally the further additives, and the at least one processing agent based on a monocarboxylic acid;
b) grinding the at least one pyrotechnical material, optionally the further additives and the at least one processing agent based on a monocarboxylic acid to obtain a propellant composite; and
c) pressing the propellant composite to form a propellant element.

The above-described method for producing a propellant element can help produce such propellant element in a particularly simple and inexpensive manner. The addition of a processing agent based on a monocarboxylic acid specifically allows for improved mixing of the above-mentioned components in the first method step. In this way, the amount of the processing agent used can be reduced and/or a higher bulk density of the propellant composite can be obtained. Moreover, the processing agent based on a monocarboxylic acid serves as a lubricant and as an anti-caking agent so that the handling and specifically the transfer of the propellant composite between individual receptacles used during production is facilitated. For example, the propellant composite can be transferred particularly easily from a mill into a press die without the propellant composite sticking to the walls of the mill and the press die. Without being bound to theory, it is assumed that the processing agent particularly prevents the individual components from clogging and aggregating and, accordingly, impedes or suppresses sticking of the individual components of the propellant composite to a production tool, such as a press die or a press punch.

In particular, the processing agent based on a monocarboxylic acid can be subsequently added to the already mixed components. In other words, the pyrotechnical material and, optionally, the further additives are submitted and are then mixed with the processing agent based on a monocarboxylic acid.

Preferably, the processing agent is added directly before the method step b), and thus before grinding of the individual components.

The invention thus also relates to the use of a monocarboxylic acid as a processing agent for the production of a propellant element for a safety device. Regarding the characteristics and advantages of the monocarboxylic acid, the foregoing explanations are referred to.

According to one aspect, the processing agent is a grinding and pressing agent for the production of a propellant element for a safety device.

### EXAMPLES

In the following, the invention will be described by means of examples which are not to be interpreted in a restricting sense, however.

### Example 1

55 g guanidine nitrate as fuel and 45 g basic copper nitrate as oxidizing agent are submitted. The fuel and the oxidizing agent together constitute a pyrotechnical material. Subsequently, 0.1 g n-heptanoic acid is added as processing agent to the pyrotechnical material. The components are ground together to obtain a propellant composite.

After mixing, the propellant composite has a bulk density of 0.65-0.8 g/cm³ according to DIN (German standards institute) 53466.

The propellant composite is then pressed to form a propellant element. For this purpose, a pressure of 1*104 bars is exerted upon an amount of 200 mg propellant composite so as to obtain a propellant element in the form of a pellet.

### Example 2

55 g guanidine nitrate as fuel and 30 g basic copper nitrate as well as 15 g potassium perchlorate as oxidizing agent are submitted. The fuel and the oxidizing agent together constitute a pyrotechnical material. Subsequently, 0.1 g n-heptanoic acid is added as processing agent to the pyrotechnical material. The components are ground together to obtain a propellant composite.

After mixing, the propellant composite has a bulk density of 0.65-0.8 g/cm³ according to DIN 53466.

The propellant composite is subsequently pressed to form a propellant element. For this purpose, a pressure of 1*104 bars is exerted upon an amount of 200 mg propellant composite so as to obtain a propellant element in the form of a pellet.

### Example 3

60 g guanidine nitrate as fuel and 40 g potassium perchlorate as oxidizing agent are submitted. The fuel and the oxidizing agent together constitute a pyrotechnical material. Subsequently, 0.1 g n-heptanoic acid is added as processing agent to the pyrotechnical material. The components are ground together to obtain a propellant composite.

After mixing, the propellant composite has a bulk density of 0.4-0.7 g/cm³ according to DIN 53466.

The propellant composite is subsequently pressed to form a propellant element. For this purpose, a pressure of 1*104 bars is exerted upon an amount of 50 mg propellant composite so as to obtain a propellant element in the form of a pellet.

### Example 4

53 g guanidine nitrate as fuel and 47 g basic copper nitrate as oxidizing agent are mixed. The fuel and the oxidizing agent together constitute a pyrotechnical material. Subsequently, 0.1 g n-heptanoic acid is added as processing agent to the pyrotechnical material. The components are ground together to obtain a propellant composite.

After mixing, the propellant composite has a bulk density of 0.65-0.8 g/cm³ according to DIN 53466.

The propellant composite is subsequently pressed to form a propellant element. For this purpose, a pressure of 1*104 bars is exerted upon an amount of 100 mg propellant composite so as to obtain a propellant element in the form of a pellet.

### Reference Example 1

52 g guanidine nitrate as fuel and 48 g basic copper nitrate as oxidizing agent are mixed. The fuel and the oxidizing agent together constitute a pyrotechnical material. Subsequently, 0.4 g calcium stearate is added as processing agent to the pyrotechnical material. The components are ground together to obtain a propellant composite.

After mixing, the propellant composite has a bulk density of 0.55-0.7 g/cm³ according to DIN 53466.

The propellant composite is subsequently pressed to form a propellant element. For this purpose, a pressure of 1*104 bars is exerted upon an amount of 200 mg propellant composite so as to obtain a propellant element in the form of a pellet.

Reference example 1 illustrates that the fourfold amount of a processing agent which is not according to the invention like calcium stearate must be used to obtain a flowable and properly processable propellant composite having a comparable bulk density. Compared to that, in the examples according to the invention a significantly reduced amount of processing agent can be used. Thus, the oxygen balance of the propellant element can be optimized, as the ranges for the other components present in the propellant element can be broadened. This permits to use a higher amount of fuel in the propellant element, for example.

### Reference Example 2

52 g guanidine nitrate as fuel and 48 g basic copper nitrate as oxidizing agent are mixed. The fuel and the oxidizing agent together constitute a pyrotechnical material. Subsequently, 0.1 g calcium stearate is added as processing agent to the pyrotechnical material. The components are ground together to obtain a propellant composite.

After mixing, the propellant composite has a bulk density of 0.5-0.65 g/cm³ according to DIN 53466.

The propellant composite is then pressed to form a propellant element. For this purpose, a pressure of 1*104 bars is exerted upon an amount of 200 mg propellant composite so as to obtain a propellant element in the form of a pellet.

Reference example 2 verifies that using a processing agent which is not according to the invention to the same amount as the processing agent according to the invention results in a propellant composite having a reduced bulk density. The reduced bulk density results in worse flowability and processability of the propellant composite as compared to a propellant composite which was produced with a processing agent according to the invention. Thus, it can be concluded from the reference example 2 that a higher amount of processing agent which is not according to the invention must be used to achieve the same flowability and processability as in a propellant composite including a processing agent according to the invention.

1. A propellant element for a safety device, the propellant element comprising the following components:
(A) at least one pyrotechnical material;
(B) at least one processing agent based on a monocarboxylic acid with the following formula
R—COOH
wherein R is an organic residue.

2. The propellant element according to claim 1, wherein the organic residue R comprises an aliphatic and/or aromatic hydrocarbon skeleton, preferably a homoaromatic or heteroaromatic hydrocarbon skeleton and/or a linear, branched or cyclic, saturated or unsaturated hydrocarbon skeleton, wherein the aliphatic hydrocarbon skeleton optionally includes at least one heteroatom which is selected from the group consisting of an oxygen atom, nitrogen atom, sulfur atom and phosphorus atom.

3. The propellant element according to claim 2, wherein the hydrocarbon skeleton is selected from the group consisting of C₁-C₁₇ alkyl, C₂-C₁₇ alkenyl, C₂-C₁₇ alkynyl, C₆-C₁₂ cycloalkyl and C₆-C₁₄ aryl as well as mixtures thereof.

4. The propellant element according to claim 1, wherein the monocarboxylic acid is a linear alkanoic acid with the sum formula CₙH₂ₙ₊₁COOH, wherein n is a natural number from 1 to 17, preferably from 3 to 12, particularly preferred from 4 to 9, further preferred that the monocarboxylic acid is n-heptanoic acid.

5. The propellant element according to claim 1, wherein the monocarboxylic acid is liquid at room temperature.

6. The propellant element according to claim 1, wherein the monocarboxylic acid has a melting point ranging from 25 to 70° C.

7. The propellant element according to claim 1, wherein the propellant element comprises the following components:
(A) 85 to 99.9% by weight of the at least one pyrotechnical material,
(B) 0.01 to 5% by weight of the at least one flow control agent based on a monocarboxylic acid, preferably a monocarboxylic acid having a C₃-C₉ alkyl residue, and
(C) 0 to 15% by weight of further additives,
wherein the proportions of the components (A) to (C) add up to 100 percent.

8. A method for producing a propellant element according to claim 1, wherein the method includes the following steps:
a) mixing the at least one pyrotechnical material, optionally the further additives and the at least one processing agent based on a monocarboxylic acid;
b) grinding the at least one pyrotechnical material, optionally the further additives and the at least one processing agent based on a monocarboxylic acid to obtain a propellant composite; and
c) pressing the propellant composite to form a propellant element.

9. Use of a monocarboxylic acid as a processing agent for the production of a propellant element for a safety device.

10. The use of a monocarboxylic acid according to claim 9, wherein the processing agent is a grinding and pressing agent.

11. The propellant element according to claim 1, wherein the monocarboxylic acid has a melting point ranging from 50 to 65° C.

12. The propellant element according to claim 1, wherein the monocarboxylic acid has a melting point ranging from 55 to 60° C.

13. The propellant element according to claim 1, wherein the propellant element comprises the following components:
(A) 90 to 98% by weight of the at least one pyrotechnical material,
(B) preferably 0.05 to 1% by weight of the at least one flow control agent based on a monocarboxylic acid, preferably a monocarboxylic acid having a C₃-C₉ alkyl residue, and
(C) preferably 1 to 9% by weight of further additives,
wherein the proportions of the components (A) to (C) add up to 100 percent.

14. The propellant element according to claim 1, wherein the propellant element comprises the following components:
(A) 90 to 98% by weight of the at least one pyrotechnical material,
(B) 0.1 to 1% by weight of the at least one flow control agent based on a monocarboxylic acid, preferably a monocarboxylic acid having a C₃-C₉ alkyl residue, and
(C) 1 to 9% by weight, of further additives,
wherein the proportions of the components (A) to (C) add up to 100 percent.
